(19) United States
(12) Patent Application Publication
(10) Pub. No.: US 2012/0062471 A1
(43) Pub. Date: Mar. 15, 2012

(54) HANDHELD DEVICE WITH GESTURE-BASED VIDEO INTERACTION AND METHODS FOR USE THEREWITH

(76) Inventors: Philip Poulidis, Oakville (CA); Feng Chi Wang, Austin, TX (US)

(21) Appl. No.: 12/880,550

(22) Filed: Sep. 13, 2010

(51) Int. Cl. G06F 3/041

(52) U.S. Cl. 345/173

(57) ABSTRACT

A handheld device includes a wireless interface module that communicates a plurality of display interface data with a remote display device. The handheld device recognizes gestures in response to user interaction with the touch screen. A video application controls the communication of media signals between the handheld device and the remote display device via the display interface data, based on the recognized gestures.

### TECHNICAL FIELD OF THE INVENTION

The present invention relates to transfer of media content and related methods used in devices such as set-top boxes and other home media gateways.

### DESCRIPTION OF RELATED ART

The number of households having multiple television sets is increasing, and many users want the latest and greatest video viewing services. As such, many households have multiple satellite receivers, cable set-top boxes, modems, et cetera. For in-home Internet access, each computer or Internet device can have its own Internet connection. As such, each computer or Internet device includes a modem.

As an alternative, an in-home wireless local area network may be used to provide Internet access and to communicate multimedia information to multiple devices within the home. In such an in-home local area network, each computer or Internet device includes a network card to access an IP gateway. The gateway provides the coupling to the Internet. The in-home wireless local area network can also be used to facilitate an in-home computer network that couples a plurality of computers with one or more printers, facsimile machines, as well as to multimedia content from a digital video recorder, set-top box, broadband video system, etc.

In addition, many mobile devices, such as smart phones, netbooks, notebooks and tablet personal computing devices are capable of viewing video programming, either through the use of a television tuner card, or via streaming video thru either free or subscriptions services. Mobile devices are becoming a ubiquitous presence in the home, office and wherever else users happen to be.

The limitations and disadvantages of conventional and traditional approaches will become apparent to one of ordinary skill in the art through comparison of such systems with the present invention.

### BRIEF DESCRIPTION OF THE SEVERAL VIEWS OF THE DRAWINGS

FIG. 1 presents a pictorial representation of a handheld device 10 and display device 12 in accordance with an embodiment of the present invention.

FIG. 2 presents a block diagram representation of a handheld device 10 and display device 12 in accordance with an embodiment of the present invention.

FIG. 3 presents a pictorial representation of a sequence of screen displays in accordance with an embodiment of the present invention.

FIG. 4 presents a graphical representation of a plurality of gestures in accordance with an embodiment of the present invention.

FIG. 5 presents a graphical representation of a touch screen trajectory in accordance with an embodiment of the present invention.

FIG. 6 presents a graphical representation of touch screen trajectories in accordance with an embodiment of the present invention.

FIG. 7 presents a pictorial representation of a screen display 322 in accordance with an embodiment of the present invention.

FIG. 8 presents a pictorial representation of a screen display 324 in accordance with an embodiment of the present invention.

FIG. 9 presents a block diagram representation of a handheld device 14 and display device 12 in accordance with an embodiment of the present invention.

FIG. 10 presents a pictorial representation of a sequence of screen displays in accordance with an embodiment of the present invention.

FIG. 11 presents a flowchart representation of a method in accordance with an embodiment of the present invention.

FIG. 12 presents a flowchart representation of a method in accordance with an embodiment of the present invention.

FIG. 13 presents a flowchart representation of a method in accordance with an embodiment of the present invention.

FIG. 14 presents a flowchart representation of a method in accordance with an embodiment of the present invention.

FIG. 15 presents a flowchart representation of a method in accordance with an embodiment of the present invention.

FIG. 16 presents a flowchart representation of a method in accordance with an embodiment of the present invention.

### DETAILED DESCRIPTION OF THE INVENTION INCLUDING THE PRESENTLY PREFERRED EMBODIMENTS

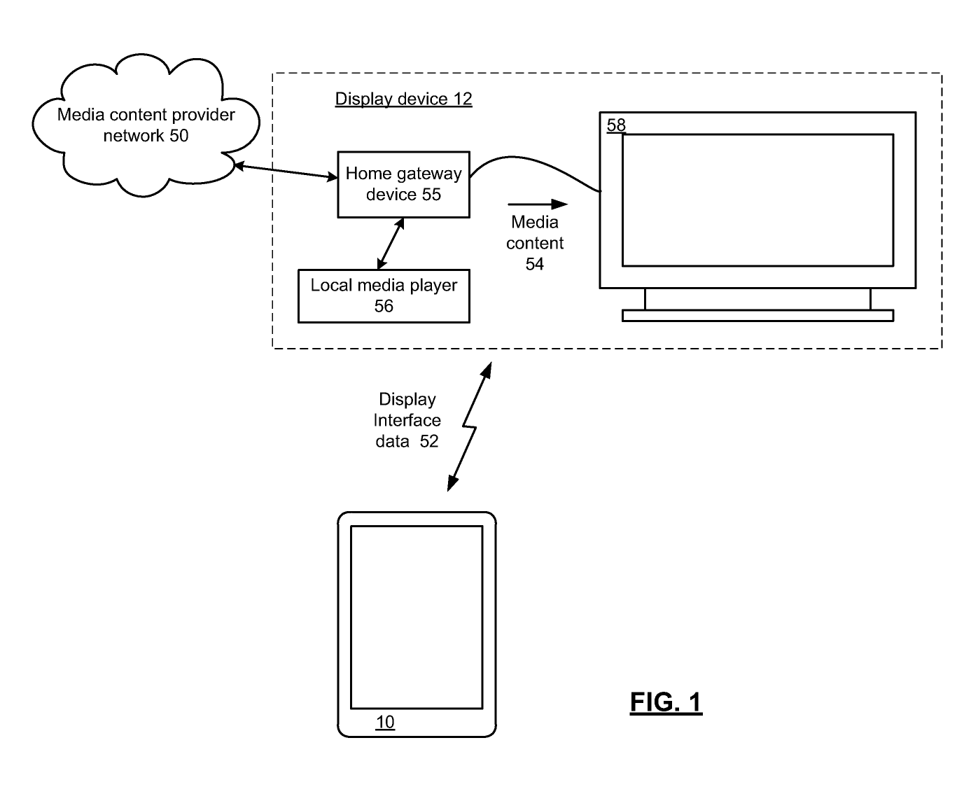

FIG. 1 presents a pictorial representation of a handheld device 10 and display device 12 in accordance with an embodiment of the present invention. A media content provider network 50 is coupled to a display 58 via a home gateway device 55, such as a multimedia server, personal video recorder, set-top box, personal computer, wireless local area network (WLAN) access point, cable television receiver, satellite broadcast receiver, broadband modem, 3G or 4G transceiver or other media gateway or transceiver that is capable of receiving a media content 54 from media content provider network 50. In addition, media content 54 can be generated locally from a local media player 56 such as a game console, DVD player or other media player that is included in the display 58, directly coupled to the display 58 or indirectly coupled to the display 58 via the home gateway device 55, as shown.

The media content 54 can be in the form of one or more video signals, audio signals, text, games, multimedia signals or other media signals that are either realtime signals in analog or digital format or data files that contain media content in a digital format. For instance, such media content can be included in a broadcast video signal, such as a television signal, high definition television signal, enhanced high definition television signal or other broadcast video signal that has been transmitted over a wireless medium, either directly or through one or more satellites or other relay stations or through a cable network, optical network, IP television network, or other transmission network. Further, such media content can be included in a digital audio or video file, transferred from a storage medium such as a server memory, magnetic tape, magnetic disk or optical disk, or can be included in a streaming audio or video signal that is transmitted over a public or private network such as a wireless or wired data network, local area network, wide area network, metropolitan area network or the Internet.

Home media gateway device 55 is coupled to optionally play audio and video portions of the media content 54 on display 58. Display 58 can include a television, monitor, computer or other video display device that creates an optical image stream either directly or indirectly, such as by optical transmission or projection, and/or that produces an audio output from media content 54. While the home gateway device 55 and display 58 are shown as separate devices, the functionality of home gateway device 55 and display 58 may be combined in a single unit. As used herein, display device 12 is a single device or multiple devices that include one or more components of the home gateway device 55, display 58 and local media player 56 or that otherwise handle different media content 54 for display and are capable of generating and communicating display interface data 52 as disclosed herein.

The handheld device 10 can be a smart phone, netbook, notebook, tablet personal computing device, portable game player, or other mobile device that is capable of displaying media content 54. The handheld device 10 and the display device 12 each include compatible wireless transceivers for communicating display interface data 52 therebetween. The handheld device 10 is capable of recognizing gestures of the user when interacting with a touch screen or touch pad of the handheld device 10. In various embodiments and modes of operation of the present invention, video application of the handheld device 10 controls the communication of media signals between the handheld device 10 and the remote display device 12 via the display interface data 52, based on the recognized gestures.

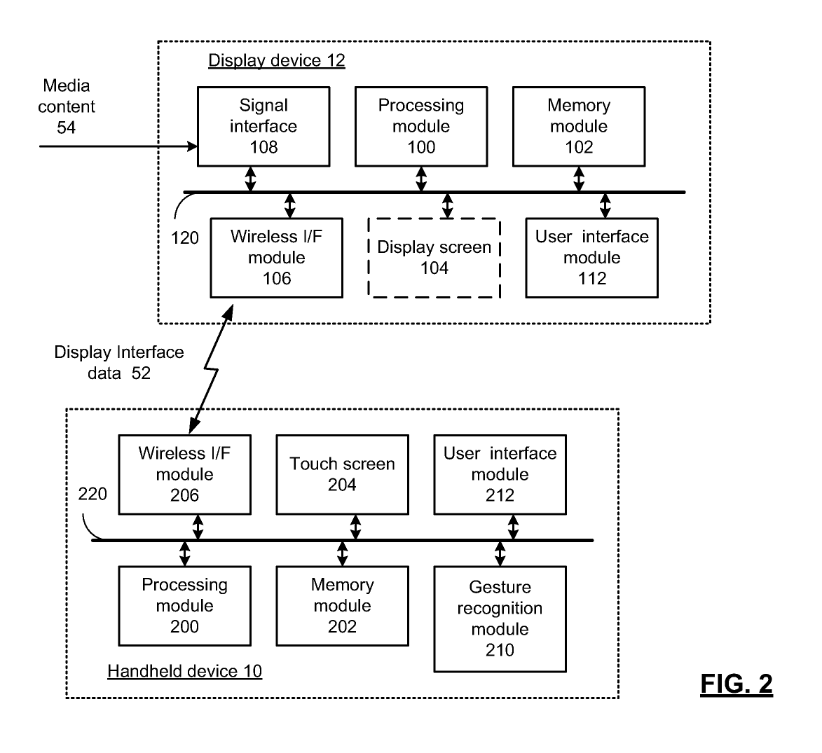

Further details regarding the present invention including alternative embodiments, optional implementations, functions and features are presented in conjunction with FIGS. 2-16 that follow.

FIG. 2 presents a block diagram representation of a handheld device 10 and display device 12 in accordance with an embodiment of the present invention. The display device 12 includes a processing module 100, memory module 102, wireless interface module 106, signal interface 108, user interface module 112 and optionally optionally, display screen 104, that are interconnected via bus 120. The handheld device 10 includes a processing module 200, memory module 202, touch screen 204, wireless interface module 206, gesture recognition module 210 and user interface module 212 that are interconnected via bus 220.

Processing module 100 controls the operation of the display device 12 and/or provides processing required by other modules of the display device 12. Processing module 200 controls the operation of the handheld device 10 and/or provides processing required by other modules of the handheld device 10. Processing modules 100 and 200 can each be implemented using a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions that are stored in a memory, such as memory modules 102 and 202. Memory modules 102 and 202 may each be a single memory device or a plurality of memory devices. Such a memory device can include a hard disk drive or other disk drive, read-only memory, random access memory, volatile memory, non-volatile memory, static memory, dynamic memory, flash memory, cache memory, and/or any device that stores digital information. Note that when the processing module implements one or more of its functions via a state machine, analog circuitry, digital circuitry, and/or logic circuitry, the memory storing the corresponding operational instructions may be embedded within, or external to, the circuitry comprising the state machine, analog circuitry, digital circuitry, and/or logic circuitry. While a particular bus structures are shown, other architectures, including the use of additional busses and/or direct connectivity between elements are likewise possible.

Signal interface 108 can operate via a wired link for receiving media content 54 from either home gateway 55, local media player 56, or directly from a media content provider network 50. The signal interface 108 can include an Ethernet connection, Universal Serial Bus (USB) connection, an Institute of Electrical and Electronics Engineers (IEEE) 1394 (Firewire) connection, small computer serial interface (SCSI) connection, a composite video, component video, S-video, analog audio, video graphics array (VGA), digital visual interface (DVI) and/or high definition multimedia interface (HDMI) connection or other wired connection that operates in accordance with either a standard or custom interface protocol. Signal interface 108 can also operate via a wireless link that operates in accordance with a wireless network protocol such as 802.11a,b,g,n (referred to generically as 802.11x), Ultra Wideband (UWB), 3G or 4G or other wireless connection that operates in accordance with either a standard or custom interface protocol in order to receive media content 54.

The display screen 204 can include a liquid crystal display, cathode ray tube, plasma display, light emitting diode display or any other display screen 204 that creates an optical image stream either directly or indirectly, such as by optical transmission or projection, and/or that produces an audio output from media content 54. The user interface module, 112 can include one or more buttons or switches, soft keys, a remote control device, such as an infrared or other wireless and remote control interface that communicates with the remote control device, a graphical user interface, in addition to other devices and drivers that allow the user to interact with the display device 12.

Wireless interface module 106 includes one or more wireless transceivers for bidirectionally communicating display interface data 52 between the display device 12 and the handheld device 10 via wireless interface module 206. Wireless interfaces 106 and 206 can each be wireless RF transceivers that operate in accordance with a communication protocol such as Bluetooth, Zigbee, 802.11x, Infrared Data Association (IrDA) or other or other wireless protocol.

The touch screen 204 can include a resistive touch screen, capacitive touch screen or any other display screen 204 that creates an optical image stream either directly or indirectly, such as by optical transmission or projection, and further that generates touch data in response to the touch of the touch screen 204 or near touch by a user, a stylus or other pointing object. Gesture recognition module 210 operates in conjunction with touch screen 204 to analyze touch data generated by the touch screen 204. In particular, gesture recognition module operates via pattern recognition, artificial intelligence, mathematical analysis or other processing to recognize touch-based gestures, such as swipes and other gestures of the user of handheld device 10 when interacting with the touch screen 204. The user interface module, 212 can include one or more buttons or switches, a graphical user interface that operates in conjunction with touch screen 204, a microphone, and/or speaker, in addition to other devices and drivers that allow the user to interact with the handheld device 10.

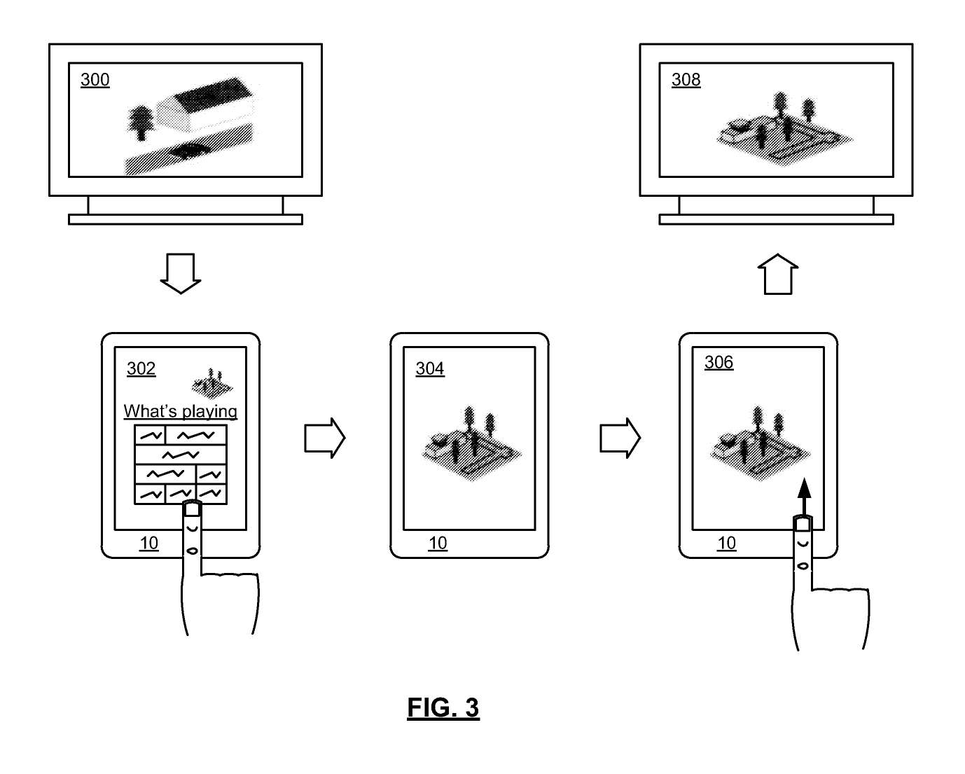

On operation, processing module 200 executes a video application to coordinate the operation of handheld device 10 in conjunction with the display device 12. As discussed in association with FIG. 1, the video application operates based on the recognized gestures of the user to control the communication of media content between the handheld device 10 and the display device 12 via the display interface data 52. The video application further operates in conjunction with program information received via display interface data 52 to generate an electronic program guide for selecting video programming and other media content 54. In examples where handheld device 10 is implemented via an Apple iPhone, iPad or similar device, the video application can be an ‘app” that is downloaded to the device from a remote server, selected from a main menu and executed in response to commands from the user. The video application can similarly be an Android or Microsoft application used in conjunction with other compatible devices. The video application can otherwise be implemented via other software or firmware. The operation of the video application can be described in conjunction with the following examples presented in conjunction with, for instance, FIGS. 3 and 11-16.

FIG. 3 presents a pictorial representation of a sequence of screen displays in accordance with an embodiment of the present invention. In particular screen displays 300, 302, 304, 306 and 308 illustrate an example of operation of a video application of handheld device 10 and its interoperation with display device 12.

In this example, a display 58 or display screen 104 of display device 12 is displaying a video program represented by screen display 300. The video application of handheld device 10 receives program guide information from the display device 12 via display interface data 52. In response, the video application displays a program guide on the touch screen 204, based on the program guide information, as shown in screen display 302. The program guide can take on many different forms. In the example shown, the program guide includes a grid. While each cell in the grid is shown as containing symbols, in an embodiment of the present invention, each cell can contain a program title, genre, rating, time, reviews and/or other information of interest to a user in selecting a particular program. The cells can represent currently playing broadcast channels, video on demand offerings, video programs or other media content available for either streaming or download, and/or video programs or other media content available via local media player 56. In addition, the program guide can contain a portion of the screen, either in a cell or outside of a cell (as shown) that either previews a particular video selection—such as a video on demand offering or shows what is currently playing on a broadcast channel or other source.

The user interacts with the program guide that is displayed on the touch screen to select a particular video program. In response, the video application generates display interface data 52 that indicates the selection of the particular video program and sends the display interface data 52 to the display device 12 via the wireless interface module 206. In turn, the display device 12 generates display interface data 52 that includes a video signal of the selected program that is received by the handheld device 10 via wireless interface module 206. Such video signals can be transferred in a digital format such as a Motion Picture Experts Group (MPEG) format (such as MPEG1, MPEG2 or MPEG4), Quicklime format, Real Media format, Windows Media Video (WMV) or Audio Video Interleave (AVI), or another digital video format, either standard or proprietary. The video signal can be decoded and displayed on the touch screen 204 as shown in screen display 304. In this fashion, a user of both display device 12 and handheld device 10 can watch a video program or other media content on display device 12, but select another video program or other media content to be viewed or previewed on handheld device 10.

Continuing further with the example, the handheld device 10 is further operable to recognize, via the gesture recognition module 210, a gesture that corresponds to the desire of the user to accept the program being viewed or previewed on handheld device 10 for display on display device 12. In particular, a gesture is represented by an arrow superimposed over the screen display 306. In response, the video application generates display interface data 52 to include a command to switch the display device 12 to display of the program or other media content being displayed on handheld device 10. The wireless interface module 206 sends the display interface data 52 to the display device 12 and the display device 12 responds by displaying the selected program as shown on screen display 308. In particular, the display device 12 can switch the display to the video signal being sent to handheld device 10 via display interface data 52—providing an uninterrupted viewing of the same program. It should be noted that, in the example above, display of the selected program on the handheld device 10 can continue or discontinue after the display device 12 responds by displaying the selected program, either at user option or based on a default setting or based on user preferences prestored in memory 202.

In addition to the example described above, other gestures of the user read by touch screen 204 can be used to control other displays of media content 54. In a further example, the gesture recognition module 210 can recognize a second gesture corresponding to a swap video command that swaps the programs being displayed on the handheld device 10 and the display device 12 with one another. When the second gesture is recognized, the video application generates display interface data 52 to include the swap video command and sends the display interface data 52 to the display device 12 via the wireless interface module 206. In response, the display device 12 switches the video signal being sent to handheld device 10 via display interface data 52 to the video signal that the display device was displaying, while switching the video signal previously being sent to handheld device 10 to be currently displayed on display device 12.

In this fashion, for instance, a display device 12 with two tuners or otherwise with two sources of video programming or other media can switch between two programs in a mode that is similar to traditional picture-in-picture, but with a first program displayed on the display device 12 and a second program displayed on handheld device 10. The swap command operates to swap the video programs so that the second program is displayed on the display device 12 and the first program is displayed on handheld device 10.

In another example, the user of handheld device 10 can execute a fetch video command to switch the display of the handheld device 10 to the video program or media content being displayed on display device 12. In particular, the gesture recognition module 210 can recognize a third gesture of a plurality of gestures corresponding to the fetch video command. When the third gesture is recognized, the video application generates display interface data 52 to include the fetch video command and sends the display interface data 52 to the display device 12 via the wireless interface module 206. In response, the display device 12 switches or initiates the transmission of a video signal to handheld device 10 via display interface data 52 corresponding to the video program that the display device is currently displaying.

Other gestures recognized by gesture recognition module 210 can be used for other purposes such as channel up and down commands that are used by display device 12 to change the video signal sent to handheld device 10 via display interface data 52. For instance, in response to the gesture recognition module 210 recognizing a gesture that corresponds to a channel change command, the video application can generate display interface data 52 that includes the channel change command and send the display interface data 52 to the display device 12 via the wireless interface module 206. In response, the display device 12 can change the video signal or other media content sent to the handheld device 10 via the display interface data 52, in accordance with the channel change command.

It should be noted that the examples above are merely illustrative of the wide range of uses of gesture commands in terms of the interaction between handheld device 10 and display device 12.

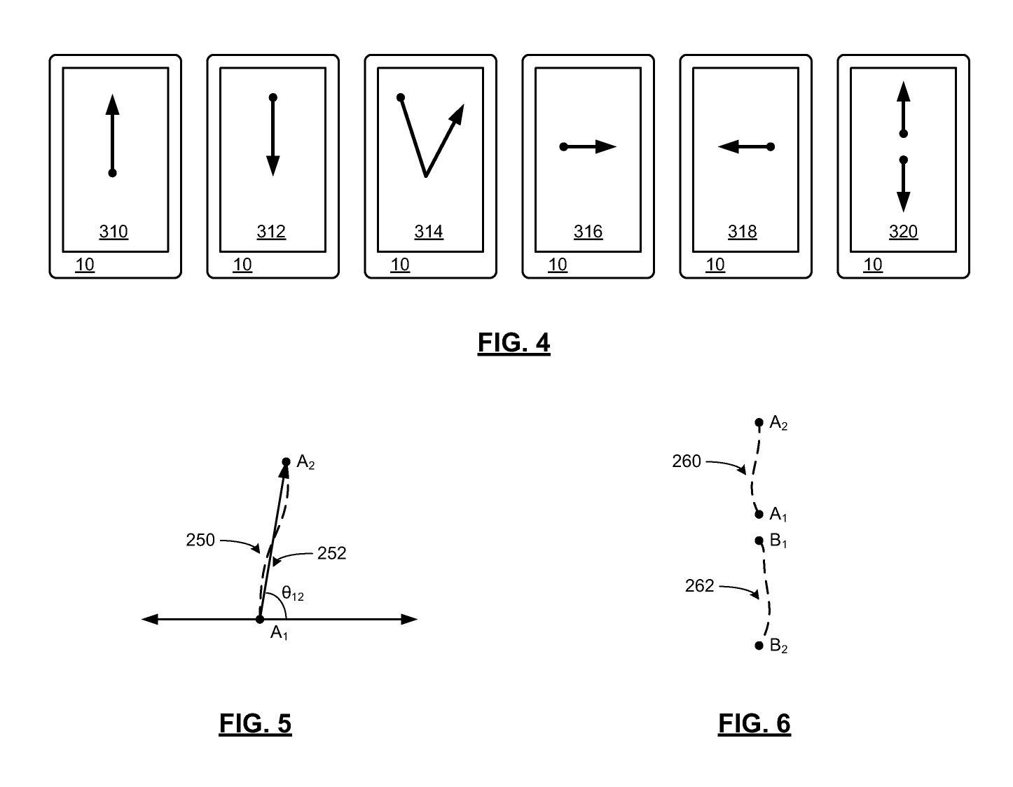

FIG. 4 presents a graphical representation of a plurality of gestures in accordance with an embodiment of the present invention. In particular, the gestures 310, 312, 314, 316, 318 and 320 represent examples of possible gestures recognized by gesture recognition module 210 and used to implement commands of a video application of handheld device 10. Gestures 310, 312, 314, 316 and 318 represent swipes of the touch screen 204 via a finger, stylus or other object of the user. The original point of the swipe is indicated by the enlarged dot with the direction and path of the swipe being represented by the direction and path of the arrow. In contrast, gesture 320 represents the direction of travel of two contemporaneous touches of touch screen—from a position where the touches are close to one another to a position where the touches are further spread apart.

In an embodiment of the present invention, the particular gestures are chosen to be related to the action in some fashion. For example, the gesture to “push” the video displayed on the handheld device 10 for display on the display device 12 can be gesture 310—a “push” from the user in the direction of the display (if the user is facing the display device 12). Similarly, a fetch command is can be initiated via a swipe 312 that, for instance, begins in the direction of the display device and continues in a direction toward the user, assuming a similar orientation. Further, the gesture to “swap” the video displayed on the handheld device 10 for display on the display device 12 can be gesture 314—a “back and forth” motion from the user in the direction of the display (if the user is facing the display device 12).

It should be noted that the examples above are merely illustrative of the wide range of possible gestures used to implement commands used in the interaction between handheld device 10 and display device 12.

FIG. 5 presents a graphical representation of a touch screen trajectory in accordance with an embodiment of the present invention. As a user interacts with touch screen 204, touch data is generated that represents the coordinates of the touch. If the user moves the touch in forming a gesture, this motion generates touch data that tracks the trajectory of the touch. In the example shown, touch screen trajectory 250 represents the motion of a user's touch of touch screen 204 in a swipe that begins at coordinate point A₁ and ends at coordinate point A₂. As shown, the trajectory deviates only slightly from a linear path.

In an embodiment of the present invention, the gesture recognition module 210 operates by extracting an angle θ₁₂ associated with the gesture, by generating a linear approximation of the touch screen trajectory 250 as shown by vector 252 and determining the orientation of the vector in terms of a coordinate system of the touch screen 204.

In an embodiment of the present invention, for linear gestures, such as gestures 310, 312, 316 and 318, the gesture recognition module 210 compares the angle θ₁₂ of the path to one or more gesture orientations θ_{i.}, for example, 0°, 90°, 180°, 270°, corresponding respectively to right, up, left, and down directions. The gesture recognition module 210 recognizes a linear gesture by comparing the angle θ₁₂ to a range of orientations, such as +/−Δθ about the ideal gesture orientations θᵢ. In particular, the gesture recognition module 210 recognizes one of the gestures 310, 312, 316 and 318 when the orientation data angle θ₁₂ compares favorably to the range of orientations about the gesture orientation θᵢ.

Following through with the example shown, consider a case where Δθ is +/−15° degrees about the ideal gesture orientations and θ₁₂=82°. The touch trajectory 250 is recognized as gesture 310 having an ideal gesture orientation of 90°, because:

75°<θ₁₂<105°

It should be further noted that gesture recognition module 210 can operate in a similar fashion to recognize compound gestures such as gesture 314 by breaking down the gestures into a sequence that includes multiple linear segments.

While particular algorithms are disclosed for recognizing gestures, such as gestures 310, 312, 314, 316 and 318 other algorithms, such as pattern recognition, clustering, curve fitting, other linear approximations and nonlinear approximations, can be employed.

FIG. 6 presents a graphical representation of touch screen trajectories in accordance with an embodiment of the present invention. While the discussion of FIG. 5 involved recognizing gestures, such as gestures 310, 312, 314, 316 and 318 with a single touch, gesture recognition module 210 can also operate to other gestures, such as gesture 320, that are generated by multiple contemporaneous touches of touch screen 204.

In the example shown, touch screen trajectory 260 represents the motion of a user's touch of touch screen 204 in a swipe that begins at coordinate point A₁ and ends at coordinate point A₂. Touch screen trajectory 262 represents the motion of a contemporaneous touch of touch screen 204 in a swipe that begins at coordinate point B₁ and ends at coordinate point B₂. In an embodiment of the present invention, the touch screen 204 generates distance data Dᵢ that represents the increase in the distance between the current point Aᵢ in trajectory 260 and the current point Bᵢ in trajectory 262. The gesture recognition module 210 can recognize the contemporaneous trajectories 260 and 262 as gesture 320 based on recognizing this increase in distance.

While particular algorithms are disclosed for recognizing gestures based on contemporaneous touches, such as gesture 320 other algorithms, such as pattern recognition, clustering, curve fitting, linear approximations and nonlinear approximations, can be employed.

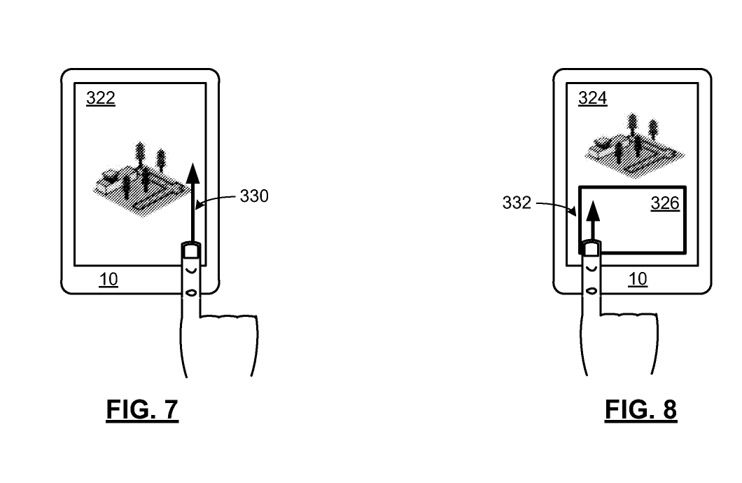

FIG. 7 presents a pictorial representation of a screen display 322 in accordance with an embodiment of the present invention. In particular, a gesture 330 is represented by an arrow superimposed over the screen display 322 of handheld device 10. For clarity, while the arrow represents the direction of the gesture 330, the arrow is not necessarily displayed. In this example, the gesture 330 is made on any area of the screen display 322 while a video program or other media content is being displayed.

FIG. 8 presents a pictorial representation of a screen display 324 in accordance with an embodiment of the present invention. In particular, a gesture 332 is represented by an arrow superimposed over the screen display 324 of handheld device 10. In this example, however, the gesture 332 is made in a dedicated area 326 of the screen display 322 while a video program or other media content is being displayed in a different area or displayed with the dedicated area 326 overlaid on the video program. As in the example of FIG. 7, while the arrow represents the direction of the gesture 332, the arrow may be displayed to provide visual feedback of the gesture 332 to the user or may not be displayed.

It should be further noted that, while touch screen 204 has been shown and described previously as being implemented via a display screen with an integral touch area, in other implementations of the present invention, a separate display screen and touch pad could be used to implement the touch screen 204 of handheld device 10. In this fashion, for instance, a netbook, notebook or other device that lacks a traditional touch screen display could implement the touch screen 204 with a separate touch pad and display screen.

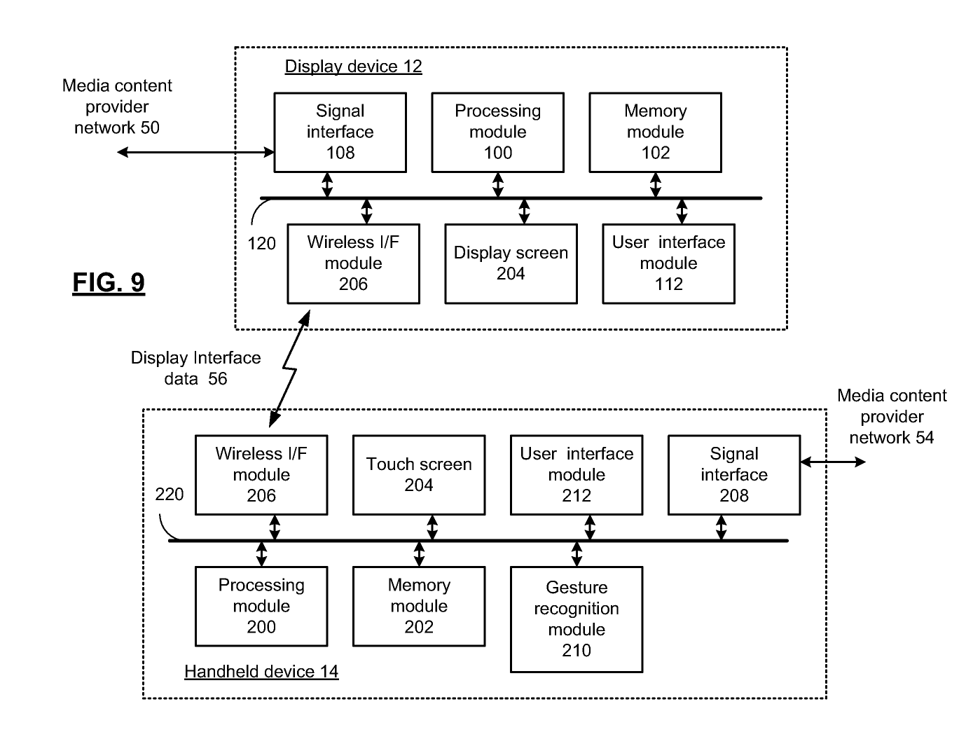

FIG. 9 presents a block diagram representation of a handheld device 14 and display device 12 in accordance with an embodiment of the present invention. In particular, handheld device 14 includes many similar elements to the handheld device 10 that are referred to by common reference numerals. In addition, the handheld device 208 includes its own signal interface 208.

Signal interface 208 can operate via a wireless link that operates in accordance with a wireless network protocol such as 802.11a,b,g,n (referred to generically as 802.11x), Ultra Wideband (UWB), 3G or 4G or other wireless connection that operates in accordance with either a standard or custom interface protocol in order to receive media content 54 via a streaming or download along with program information from a media content provider network 50. In addition, signal interface 208 can include a digital video broadcasting-handheld (DVB-H) receiver, digital video broadcasting-satellite handheld (DVB-SH) receiver, digital video broadcasting-terrestrial (DVB-T) receiver, digital video broadcasting-next generation handheld (DVB-NGH) receiver, digital video broadcasting-internet protocol datacasting (DVB-IPDC) receiver, a digital over the air broadcast television receiver, a satellite radio receiver or other receiver for directly accessing media content 54 and associated program information. In this embodiment, the video application of handheld device 14 further operates in conjunction with program information received via signal interface 208 to generate an electronic program guide for selecting video programming and other media content 54, that is directly received via signal interface 208, that is indirectly received via display interface data 52 or both.

While handheld device 14 includes the functions and features of handheld device 10, in addition, handheld device 14 can select and independently access video programming and other media content 54. Further, handheld device 14 can act as a source of video signals to display device 12 via display interface data 52. In this fashion, an additional push command can be implemented via handheld device 14 to select and push a video signal to display device 12 that is received via signal interface 208. Also, a modified swap command can be implemented to swap video being displayed between the display device 12 and the handheld device 10, based on one or two video programs or other media content 54 received via signal interface 208. Depending on the particular mode of operation, the display interface data 52 can include a video signal received via signal interface 208 and sent to display device 12 from handheld device 14, a video signal received via signal interface 108 and sent to handheld device 14 from display device 12, or both. Video programs or other media content originating from either device or both devices can be swapped back and forth in response to corresponding gesture commands and optionally based on other defaults, or prestored user preferences.

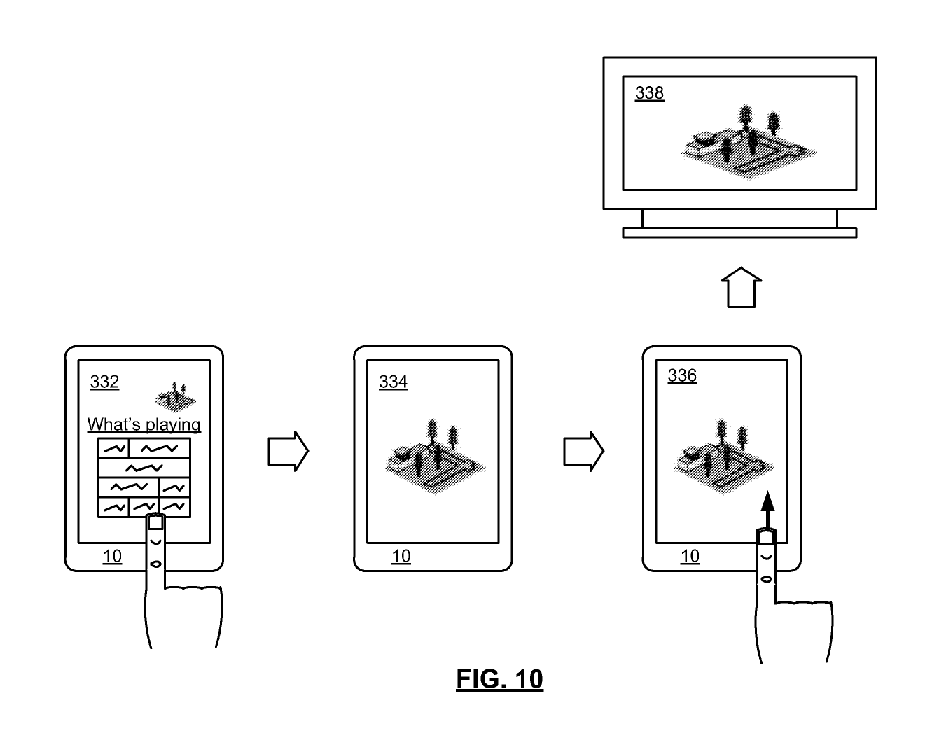

FIG. 10 presents a pictorial representation of a sequence of screen displays in accordance with an embodiment of the present invention. In particular, screen displays 332, 334, 336 and 338 illustrate an example of operation of a video application of handheld device 14 and its interoperation with display device 12.

In this example, the video application of handheld device 10 receives program guide information from the media content provider network 50 via signal interface 208. In response, the video application displays a program guide on the touch screen 204, based on the program guide information, as shown in screen display 332. The program guide can take on many different forms. In the example shown, the program guide includes a grid. While each cell in the grid is shown as containing symbols, in an embodiment of the present invention, each cell can contain a program title, genre, rating, time, reviews and/or other information of interest to a user in selecting a particular program. The cells can represent currently playing broadcast channels, video on demand offerings, video programs or other media content available for either streaming or download, and/or video programs or other media content 54 available directly or via display device 12. In addition, the program guide can contain a portion of the screen, either in a cell or outside of a cell (as shown) that either previews a particular video selection—such as a video on demand offering or shows what is currently playing on a broadcast channel or other source.

The user interacts with the program guide that is displayed on the touch screen to select a particular video program. The video signal is displayed on the touch screen 204 as shown in screen display 334. Continuing further with the example, the handheld device 10 is further operable to recognize, via the gesture recognition module 210, a gesture that corresponds to the desire of the user to push the program being viewed on handheld device 10 for display on display device 12. In particular, a gesture is represented by an arrow superimposed over the screen display 306. In response, the video application generates display interface data 52 to include the video signal corresponding to the selected program and/or a command to switch the display device 12 to display of the program or other media content being displayed on handheld device 10. The wireless interface module 206 sends the display interface data 52 to the display device 12 and the display device 12 responds by displaying the selected program as shown on screen display 308. It should be noted that, in the example above, display of the selected program on the handheld device 10 can continue or discontinue after the display device 12 responds by displaying the selected program, either at user option or based on a default setting or based on user preferences prestored in memory 202.

In addition to the example, above, other gestures recognized by gesture recognition module 210 can be used for other purposes such as channel up and down commands to change channels that are directly or indirectly received. As noted in conjunction with FIG. 9, a modified swap command can be implemented to swap video being displayed between the display device 12 and the handheld device 10, based on one or two video programs or other media content 54 received via signal interface 208.

FIG. 11 presents a flowchart representation of a method in accordance with an embodiment of the present invention. In particular, a method is presented for use with one or more functions and features described in conjunction with FIGS. 1-10. In step 400, a plurality of display interface data are communicated with a remote display device via a wireless interface module. In step 402, a video application is executed via a processor that control communication of video signals between a handheld device and the remote display device.

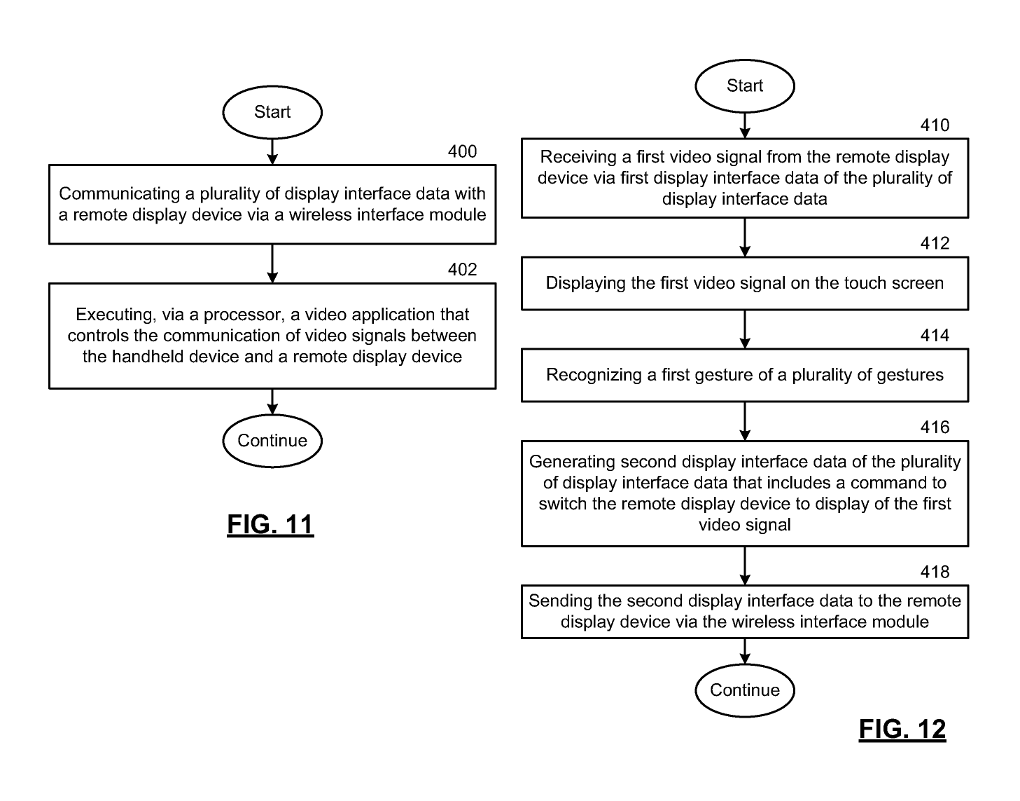

FIG. 12 presents a flowchart representation of a method in accordance with an embodiment of the present invention. In particular, a method is presented for use with one or more functions and features described in conjunction with FIGS. 1-11. In step 410, a first video signal is received from the remote display device via first display interface data of the plurality of display interface data. In step 412, the first video signal is displayed on the touch screen. In step 414, a first gesture of a plurality of gestures is recognized. In step 416, second display interface data of the plurality of display interface data is generated that includes a command to switch the remote display device to display of the first video signal. In step 418, the second display interface data is sent to the remote display device via the wireless interface module.

In an embodiment of the present invention, step 414 include analyzing a touch data trajectory generated in response to the user interaction with the touch screen to extract at least one orientation corresponding to the touch data trajectory, and recognizing the first gesture based on the at least one orientation. Step 414 can also include recognizing the first gesture of the plurality of gestures based on a difference between a plurality of contemporaneous touches by the user of the touch screen.

FIG. 13 presents a flowchart representation of a method in accordance with an embodiment of the present invention. In particular, a method is presented for use with one or more functions and features described in conjunction with FIGS. 1-12. In step 420, program guide information is received from the remote display device via third display interface data of the plurality of display interface data. In step 422, a program guide is displayed on the touch screen, based on the program guide information. In step 424, a selection of the first video signal is received in response to the user interaction with the touch screen, while the program guide is displayed. In step 426, fourth display interface data of the plurality of display interface data is generated that indicates the selection of the first video signal. In step 428, the fourth display interface data is sent to the remote display device via the wireless interface module.

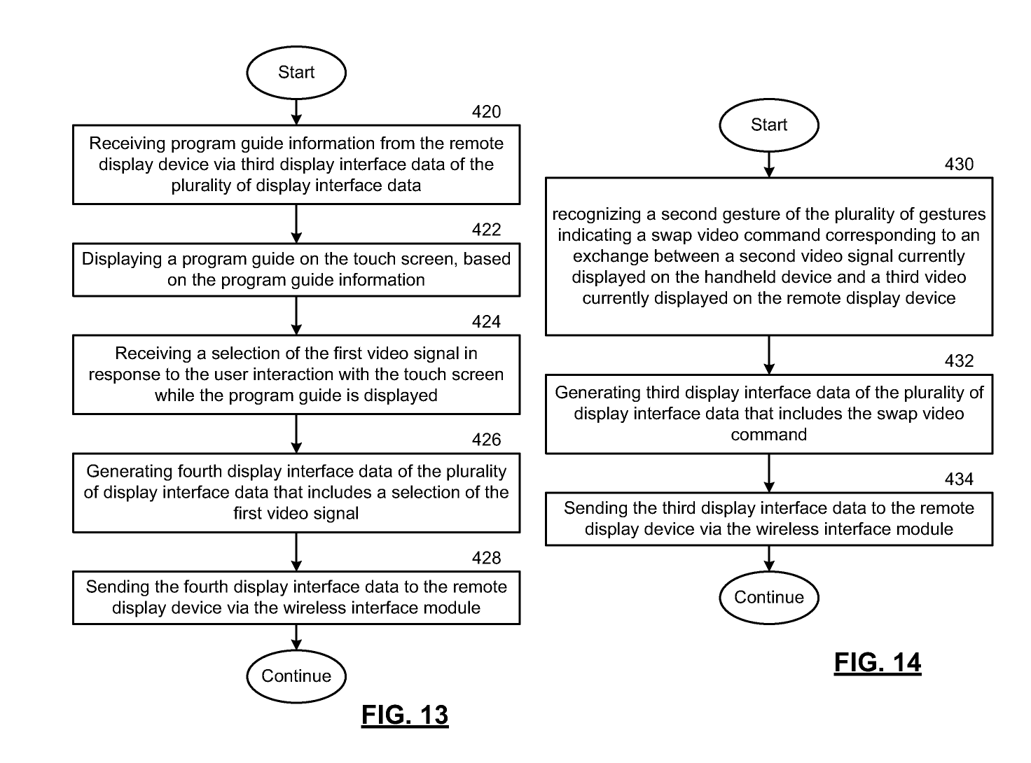

FIG. 14 presents a flowchart representation of a method in accordance with an embodiment of the present invention. In particular, a method is presented for use with one or more functions and features described in conjunction with FIGS. 1-13. In step 430, a second gesture of the plurality of gestures is recognized indicating a swap video command corresponding to an exchange between a second video signal currently displayed on the handheld device and a third video currently displayed on the remote display device. In step 432, third display interface data of the plurality of display interface data is generated that includes the swap video command. In step 434, the third display interface data is sent to the remote display device via the wireless interface module.

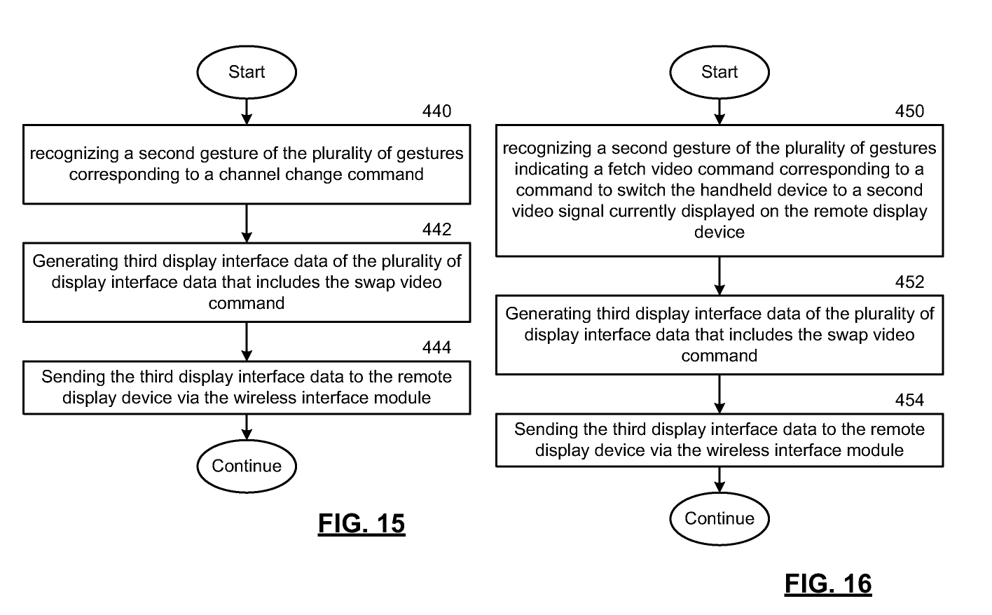

FIG. 15 presents a flowchart representation of a method in accordance with an embodiment of the present invention. In particular, a method is presented for use with one or more functions and features described in conjunction with FIGS. 1-14. In step 440, a second gesture of the plurality of gestures is recognized corresponding to a channel change command. In step 442, third display interface data of the plurality of display interface data is generated that includes the channel change command. In step 444, the third display interface data is sent to the remote display device via the wireless interface module.

FIG. 16 presents a flowchart representation of a method in accordance with an embodiment of the present invention. In particular, a method is presented for use with one or more functions and features described in conjunction with FIGS. 1-15. In step 450, a second gesture of the plurality of gestures is recognized that indicates a fetch video command corresponding to a command to switch the handheld device to a second video signal currently displayed on the remote display device. In step 452, third display interface data of the plurality of display interface data is generated that includes the fetch video command. In step 454, the third display interface data is sent to the remote display device via the wireless interface module.

In preferred embodiments, the various circuit components are implemented using 0.35 micron or smaller CMOS technology. Provided however that other circuit technologies, both integrated or non-integrated, may be used within the broad scope of the present invention.

As one of ordinary skill in the art will appreciate, the term “substantially” or “approximately”, as may be used herein, provides an industry-accepted tolerance to its corresponding term and/or relativity between items. Such an industry-accepted tolerance ranges from less than one percent to twenty percent and corresponds to, but is not limited to, component values, integrated circuit process variations, temperature variations, rise and fall times, and/or thermal noise. Such relativity between items ranges from a difference of a few percent to magnitude differences. As one of ordinary skill in the art will further appreciate, the term “coupled”, as may be used herein, includes direct coupling and indirect coupling via another component, element, circuit, or module where, for indirect coupling, the intervening component, element, circuit, or module does not modify the information of a signal but may adjust its current level, voltage level, and/or power level. As one of ordinary skill in the art will also appreciate, inferred coupling (i.e., where one element is coupled to another element by inference) includes direct and indirect coupling between two elements in the same manner as “coupled”. As one of ordinary skill in the art will further appreciate, the term “compares favorably”, as may be used herein, indicates that a comparison between two or more elements, items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1.

As the term module is used in the description of the various embodiments of the present invention, a module includes a functional block that is implemented in hardware, software, and/or firmware that performs one or module functions such as the processing of an input signal to produce an output signal. As used herein, a module may contain submodules that themselves are modules.

Thus, there has been described herein an apparatus and method, as well as several embodiments including a preferred embodiment, for implementing a handheld device and display device. Various embodiments of the present invention herein-described have features that distinguish the present invention from the prior art.

It will be apparent to those skilled in the art that the disclosed invention may be modified in numerous ways and may assume many embodiments other than the preferred forms specifically set out and described above. Accordingly, it is intended by the appended claims to cover all modifications of the invention which fall within the true spirit and scope of the invention.

What is claimed is:

1. A handheld device comprising:
a wireless interface module, for communicating a plurality of display interface data with a remote display device;
a touch screen;
a gesture recognition module, coupled to the touch screen, for recognizing a plurality of gestures in response to user interaction with the touch screen;
a processor, coupled to the wireless interface module, the touch screen and the gesture recognition module, for executing a video application for operation of the handheld device in conjunction with the remote display device, wherein the video application includes:
receiving a first video signal from the remote display device via first display interface data of the plurality of display interface data;
displaying the first video signal on the touch screen;
recognizing, via the gesture recognition module, a first gesture of the plurality of gestures;
generating second display interface data of the plurality of display interface data that includes a command to switch the remote display device to display of the first video signal; and
sending the second display interface data to the remote display device via the wireless interface module.

2. The handheld device of claim 1 wherein the video application further includes:
receiving program guide information from the remote display device via third display interface data of the plurality of display interface data;
displaying a program guide on the touch screen, based on the program guide information;
receiving a selection of the first video signal in response to the user interaction with the touch screen while the program guide is displayed;
generating fourth display interface data of the plurality of display interface data that indicates the selection of the first video signal; and
sending the fourth display interface data to the remote display device via the wireless interface module.

3. The handheld device of claim 1 wherein the video application further includes:
recognizing, via the gesture recognition module, a second gesture of the plurality of gestures indicating a swap video command corresponding to an exchange between a second video signal currently displayed on the handheld device and a third video currently displayed on he remote display device;
generating third display interface data of the plurality of display interface data that includes the swap video command; and
sending the third display interface data to the remote display device via the wireless interface module.

4. The handheld device of claim 1 wherein the video application further includes:
recognizing, via the gesture recognition module, a second gesture of the plurality of gestures corresponding to a channel change command;
generating third display interface data of the plurality of display interface data that includes the channel change command; and
sending the third display interface data to the remote display device via the wireless interface module.

5. The handheld device of claim 1 wherein the video application further includes:
recognizing, via the gesture recognition module, a second gesture of the plurality of gestures indicating a fetch video command corresponding to a command to switch the handheld device to a second video signal currently displayed on the remote display device;
generating third display interface data of the plurality of display interface data that includes the fetch video command; and
sending the third display interface data to the remote display device via the wireless interface module.

6. The handheld device of claim 1 wherein the gesture recognition module analyzes a touch data trajectory generated in response to the user interaction with the touch screen to extract and at least one orientation corresponding to the touch data trajectory, and wherein the gesture recognition module recognizes the first gesture based on the at least one orientation.

7. The handheld device of claim 1 wherein the gesture recognition module recognizes the first gesture based on a difference between a plurality of contemporaneous touches by the user of the touch screen.

8. A method for use in conjunction with a handheld device, the method comprising:
communicating a plurality of display interface data with a remote display device via a wireless interface module;
executing, via a processor, a video application for operation of the handheld device in conjunction with the remote display device, wherein the video application includes:
receiving a first video signal from the remote display device via first display interface data of the plurality of display interface data;
displaying the first video signal on the touch screen;
recognizing a first gesture of a plurality of gestures;
generating second display interface data of the plurality of display interface data that includes a command to switch the remote display device to display of the first video signal; and
sending the second display interface data to the remote display device via the wireless interface module.

9. The method of claim 8 wherein the video application further includes:
receiving program guide information from the remote display device via third display interface data of the plurality of display interface data;
displaying a program guide on the touch screen, based on the program guide information;
receiving a selection of the first video signal in response to the user interaction with the touch screen while the program guide is displayed;
generating fourth display interface data of the plurality of display interface data that indicates the selection of the first video signal; and
sending the fourth display interface data to the remote display device via the wireless interface module.

10. The method of claim 8 wherein the video application further includes:
recognizing a second gesture of the plurality of gestures indicating a swap video command corresponding to an exchange between a second video signal currently displayed on the handheld device and a third video currently displayed on the remote display device;
generating third display interface data of the plurality of display interface data that includes the swap video command; and
sending the third display interface data to the remote display device via the wireless interface module.

11. The method of claim 8 wherein the video application further includes:
recognizing a second gesture of the plurality of gestures corresponding to a channel change command;
generating third display interface data of the plurality of display interface data that includes the channel change command; and
sending the third display interface data to the remote display device via the wireless interface module.

12. The method of claim 8 wherein the video application further includes:
recognizing a second gesture of the plurality of gestures indicating a fetch video command corresponding to a command to switch the handheld device to a second video signal currently displayed on the remote display device;
generating third display interface data of the plurality of display interface data that includes the fetch video command; and
sending the third display interface data to the remote display device via the wireless interface module.

13. The method of claim 8 wherein recognizing the first gesture of the plurality of gestures includes analyzing a touch data trajectory generated in response to the user interaction with the touch screen to extract at least one orientation corresponding to the touch data trajectory, and recognizing the first gesture based on the at least one orientation.

14. The method of claim 8 wherein recognizing the first gesture of the plurality of gestures is based on a difference between a plurality of contemporaneous touches by the user of the touch screen.

15. A handheld device comprising:
a wireless interface module, for communicating a plurality of display interface data with a remote display device;
a touch screen;
a gesture recognition module, coupled to the touch screen, for recognizing a plurality of gestures in response to user interaction with the touch screen;
a signal interface for receiving a first video signal from a media content provider network;
a processor, coupled to the wireless interface module, the signal interface, the touch screen and the gesture recognition module, for executing a video application in conjunction with the remote display device, wherein the video application includes:
displaying the first video signal on the touch screen;
recognizing, via the gesture recognition module, a first gesture of the plurality of gestures;
generating first display interface data that includes the first video signal and a command to switch the remote display device to display of the first video signal; and
sending the first display interface data to the remote display device via the wireless interface module.

16. The handheld device of claim 15 wherein signal interface further receives program guide information from the media content provider network, and wherein the video application further includes;
displaying a program guide on the touch screen, based on the program guide information;
receiving a selection of the first video signal in response to the user interaction with the touch screen while the program guide is displayed.

17. The handheld device of claim 15 wherein the video application further includes:
recognizing, via the gesture recognition module, a second gesture of the plurality of gestures indicating a fetch video command corresponding to an switch at the handheld device to a second video signal currently displayed on the remote display device;
generating second display interface data of the plurality of display interface data that includes the fetch video command;
sending the second display interface data to the remote display device via the wireless interface module; and
receiving third display interface data of the plurality of display interface data that includes the second video signal.

18. The handheld device of claim 15 wherein the gesture recognition module analyzes a touch data trajectory generated in response to the user interaction with the touch screen to extract and at least one orientation corresponding to the touch data trajectory, and wherein the gesture recognition module recognizes the first gesture based on the at least one orientation.

19. The handheld device of claim 15 wherein the gesture recognition module recognizes the first gesture based on a difference between a plurality of contemporaneous touches by the user of the touch screen.
